(19) United States
(12) Patent Application Publication
(10) Pub. No.: US 2024/0427566 A1
(43) Pub. Date: Dec. 26, 2024

(54) Systems and Methods for Software Development Using Machine Learning Models

(71) Applicant: Provoke Solutions LLC, The Colony, TX (US)

(72) Inventors: Andy Lin, Irvine, CA (US); Jenna Chamra, San Diego, CA (US); Robert Anton Cooper, Milan, MI (US); Peter Lawrence Kapakos, Maple Valley, WA (US); Allen Eugene Geer, Weatherford, TX (US)

(73) Assignee: Provoke Solutions LLC, The Colony, TX (US)

(21) Appl. No.: 18/750,964

(22) Filed: Jun. 21, 2024

Related U.S. Application Data
(60) Provisional application No. 63/522,302, filed on Jun. 21, 2023.

(51) Int. Cl. G06F 8/33; G06F 8/71; G06F 11/36

(52) U.S. Cl. CPC G06F 8/33; G06F 8/71; G06F 11/3688

(57) ABSTRACT

Systems and methods for software development using machine learning models are disclosed. In one embodiment, a method for programmatically generating source code using a machine learning model includes obtaining a set of project configuration information that defines a programming task, indexing original source code in a code repository, advancing the programming task by constructing a prompt to a machine learning model to obtain new source code as an output, writing the new source code to the code repository, identifying an intervention request that requires human input to complete the programming task, obtaining human input for the intervention request from a human using digital communications as an outcome, and writing the intervention request and outcome to an intervention database.

### CROSS-REFERENCE TO RELATED APPLICATIONS

The current application claims priority to U.S. Provisional Application No. 63/522,302, filed Jun. 21, 2023, the disclosure of which is incorporated herein by reference.

### FIELD OF THE INVENTION

The present invention relates generally to software development and more specifically to generating source code using thorough prompts to generative artificial intelligence machine learning models.

### BACKGROUND OF THE INVENTION

Software is often developed by determining the goals or requirements the software is to meet, dividing the goals and requirements into sub-tasks (if appropriate or desired), generating the software code, and testing the generated code against the requirements, along with often documenting each stage of the process. At times the tasks inherent in such an approach may be done in a linear fashion, an iterative fashion, a concurrent fashion, or in any of a variety of other fashions.

Software developers unfortunately have inherent limitations, and employing software developers (or any individuals) carries various risks.

### SUMMARY OF THE INVENTION

Systems and methods for software development using machine learning models are disclosed. In one embodiment, a method for programmatically generating source code using a machine learning model includes obtaining a set of project configuration information that defines a programming task, indexing original source code in a code repository, advancing the programming task by constructing a prompt to a machine learning model to obtain new source code as an output, writing the new source code to the code repository, identifying an intervention request that requires human input to complete the programming task, obtaining human input for the intervention request from a human using digital communications as an outcome, and writing the intervention request and outcome to an intervention database.

Another embodiment also includes receiving a configuration of a digital coworker and adding details to the project configuration based upon the configuration of the digital coworker.

In a further embodiment, the project configuration information includes best practices, repo locations, and documentation locations.

In another embodiment, indexing source code in a code repository comprises vectorizing classes and methods within the source code.

In yet another embodiment, indexing source code in a code repository comprises inputting the source code to a machine learning model.

In another embodiment again, indexing source code in a code repository comprises organizing classes and methods in an abstract syntax tree (AST).

In still another embodiment, the prompt comprises project configuration information and intervention information.

In a further embodiment, the project configuration information is obtained using REST API (representational state transfer (REST) application programming interface (API)).

Another embodiment also includes validating the new source code.

In a further embodiment, validating comprises manual testing by a human within a development environment.

In another embodiment, validating comprises automated testing the source code.

Another embodiment also includes fine tuning the machine learning model based on at least one intervention outcome.

In yet another embodiment, the prompt includes a list of locations for code packages.

In another embodiment again, the prompt includes a list of best practices.

In still another embodiment, the prompt includes a list of code standards.

In a further embodiment, the prompt includes a list of past interventions and outcomes.

In another embodiment, wherein the machine learning model is a large language model (LLM).

### BRIEF DESCRIPTION OF THE DRAWINGS

FIG. 1 illustrates a source code generation system in accordance with an embodiment of the invention.

FIG. 2 conceptually illustrates modules within a code generation server in accordance with an embodiment of the invention.

FIG. 3 conceptually illustrates modules within a coworker service and interaction with other modules.

FIG. 4 conceptually illustrates a flow of code indexing in accordance with some embodiments of invention.

FIGS. 5A and 5B show an example information gathering for a prompt in accordance with an embodiment of the invention.

FIGS. 5C and 5D show an example prompt in accordance with an embodiment of the invention.

FIG. 6 illustrates a process for source code generation in accordance with an embodiment of the invention.

FIG. 7 illustrates a process for prompt generation in accordance with an embodiment of the invention.

FIG. 8 illustrates a process for source code generation in accordance with an embodiment of the invention.

FIG. 9 illustrates a process for source code generation in accordance with an embodiment of the invention.

### DETAILED DISCLOSURE OF THE INVENTION

Turning now to the drawings, systems and methods for AI generated and AI assisted software development are disclosed. Certain embodiments enable the use of generative artificial intelligence (AI), in particular large language models (LLMs), to perform complex software development tasks given the parameters of the task and a database of source code to work with.

Many embodiments of the invention incorporate machine learning models, in particular large language models (LLMs). Systems can be model agnostic, that is being capable of interfacing with a variety of models.

Some embodiments of the invention provide an AI-enabled platform that can interface with an organization's infrastructure to retrieve requirements and with human project managers to guide the software development project.

The platform can write test scripts that can be used to test code in a development environment. This would enable staff reduction by enabling fewer quality test engineers to review code from developers.

In some embodiments, requirements generation and/or high-level software design can be performed or provided by a software developer. Other software development tasks can be performed by one or more processors executing program instructions of an artificial intelligence engine. The artificial intelligence engine may, for example, be based on a large language model (LLM).

In some embodiments the LLM is trained, in part, using parameters specific to particular technology platforms. In some embodiments the LLM is trained, at least in part, using parameters specific to particular technology platforms provided by specific vendors. In some embodiments the parameters may also be specific to particular industries and/or clients.

In some embodiments the AI engine is provided with requirements and/or specifications for software to be developed, and the AI engine generates software modules for the software to be developed. In some embodiments, the AI engine in addition or instead generates test cases for the software to be developed, executes the software using the test cases, and compares results of the execution of the software with the requirements and/or specifications for the software. In some embodiments output of the AI engine can be checked by a software developer, who may note errors or inconsistencies in either the generated software or the test cases, and who may provide revised training inputs for the LLM.

### Systems for Code Generation

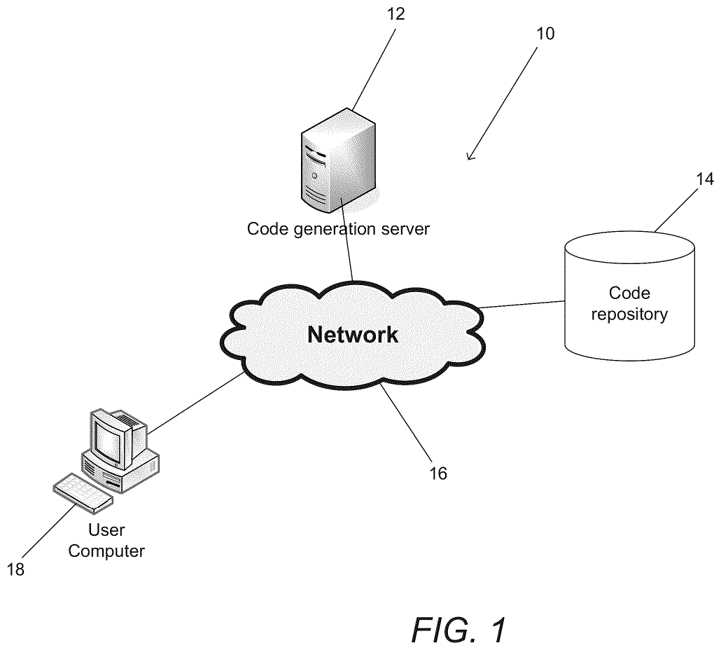

A source code generation system in accordance with an embodiment of the invention is illustrated in FIG. 1. The source code generation system 10 includes a code generation server 12, a code repository 14, and a user computer 18 that may communicate over a network. The code generation server 12 may perform processes to perform programming tasks using machine learning such as those described further below. In some embodiments, code generation server 12 is implemented in a cloud computing platform, e.g., Microsoft Azure, Amazon Web Services, as distributed computing rather than a single server. Services and modules discussed further below may be implemented as templates on the platform.

In the course of these processes, the code generation server 12 may communicate with code repository 14 that stores source code. Aspects of the code generation processes may be configured or controlled by user computer 18, such as by specifying project configuration information. Although a code generation system is described here with respect to FIG. 1, one skilled in the art will recognize that any of a variety of code generation systems may be utilized in accordance with embodiments of the invention.

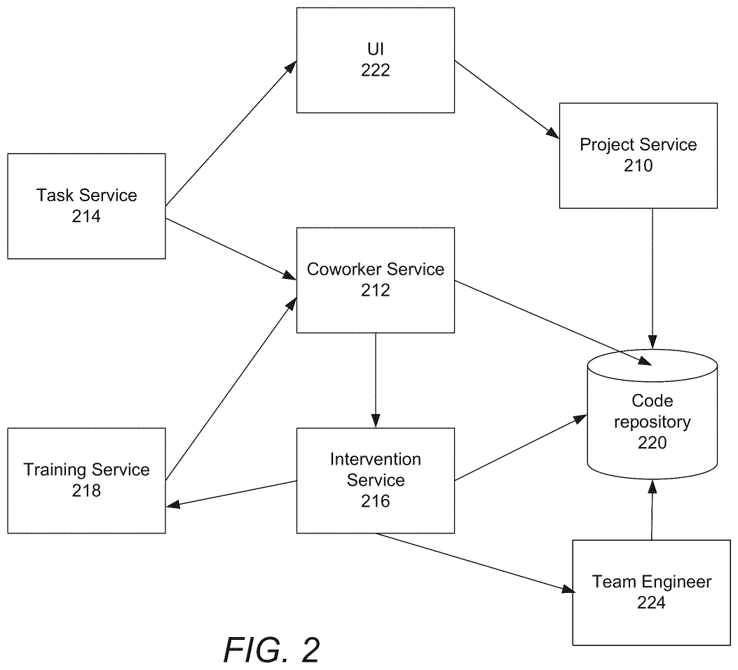

Modules of a code generation server (or service implemented in a cloud computing platform) are conceptually illustrated in FIG. 2. A code generation server (or cloud implementation) may include modules such as a project service module 210, coworker service module 212, task service module 214, intervention service module 216, and/or training service module 218. The modules may access a code repository 220 for retrieving existing source code and adding newly written source code. In some embodiments, the code repository 220 is a separate entity from the code generation server and may communicated with over a network. Code repository 220 can be a database of source code, or a developer platform, such as GitHub, Azure DevOps, etc.

A user interface 222 may be provided for access and for input of items such as project configuration. The user interface may also display dashboards showing the status of task progress. In some embodiments, the user interface 222 is on a user device that is a separate entity from the code generation server that may communicated with over a network.

A project service module 210 in many embodiments of the invention can store configuration information for projects and includes a code index, as well as perform the indexing of source code in a code repository to form the code index. Project information can include identification of what libraries are in the target software application, how the application is structured, identification of what best practices and coding standards should be used, and/or some portion of or reference to the index of the code making up the application. A project service module may include a configuration module, a Retrieval augmented generation (RAG) module, a repo handler, and/or an indexing module.

The configuration module may handle project configuration requests made on a user interface. It can persist project level configuration information, such as best practices, repo locations, documentation locations, etc. and store the information in a configuration database.

The project service module may communicate project information to a coworker service module by REST API (representational state transfer (REST) application programming interface (API)). For example, the coworker service module may query for project information in a code generation process such as those described further below.

A Retrieval augmented generation (RAG) module may handle RAG requests from the coworker service by processing tasks and querying the code index and configuration module to augment LLM prompts. Retrieval augmented generation (RAG) is a technique for providing additional custom data when querying an LLM model, rather than relying solely on knowledge derived from the model's training data. Relevant information is retrieved and used as augmented context for the LLM. RAG allows a response to use newer data than the model was trained on, reduces hallucinations, provides domain-specific responses, and is efficient in not having to retrain a model.

A repo handler may interface with the code repository 220 and handle code change events. When updates to the code repository 220 are made, the repo handler can reindex the code index.

The indexing module manages summarizing the code repository information and vectorizing the data for RAG use in a code index database in certain embodiments of the invention. In some embodiments, the code index is an SQL database. In other embodiments, the code index is a vector database with embeddings for nearest neighbor searches. Indexing will be discussed in greater detail further below.

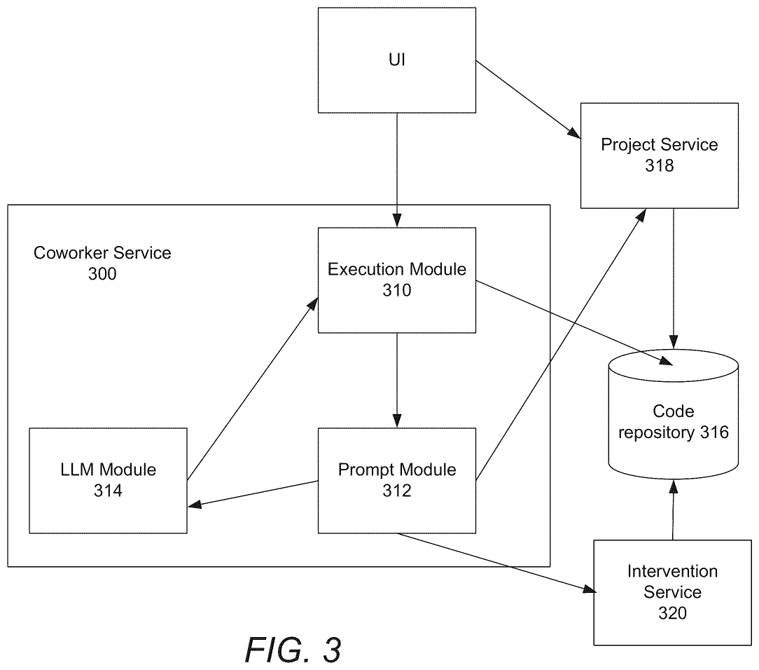

A coworker service module 212 in several embodiments of the invention can include an execution module, a prompt module, and/or an LLM module. The relationships between modules of a coworker service module 300 and with other elements in accordance with some embodiments of the invention are conceptually illustrated in FIG. 3.

The execution module 310 may coordinate activities related to task execution and publish code and task status. It can retrieve a task, set status in a status module, obtain prompts from the prompt module, interact with an LLM using the LLM module, publish interventions through the intervention service module, publish source code in the code repository 316, and/or run generated code in a development environment. The coordination of these activities as related to one instantiation of a service can be referred to here as a digital coworker or a coworker service.

The prompt module 312 can generate prompts to the LLM models for generating code according to the project information. It may take the general task specified in project information as a base prompt and utilize RAG to incorporate intervention information and/or additional project information (e.g., location and structure of code, etc.). The prompt module may obtain (e.g., query for using API calls) project information from the project service module 318 and intervention information from the intervention service module 320. More details on the construction of prompts will be discussed further below.

The LLM module 314 may manage different LLM versions and access to them.

A task service module 214 may provide functionality related to creating, delegating, and maintaining status of tasks to achieve the goal of the project. Tasks can be defined as actions with respect to code that involve generating a prompt for the LLM. Tasks may also be generated by the LLM and mapped to subtasks, particularly when the model is provided with examples. Tasks may be published to the coworker service module which can return updates. Tasks can also be shown on the user interface. A task database can store a task queue of tasks and optionally a history. The task queue can be synchronized with a project management tool such as Jira.

An intervention service module 216 may provide functionality related to actions that require human input for the coworker service. Interventions can be defined as events arising during execution of a coworker service that require input from or correction by a human (e.g., developer/engineer). Interventions can include actions such as, but not limited to, signing in to an account, changing passwords, etc.

An intervention may be expressed as a communication through email or a messaging platform (e.g., Slack, Microsoft Teams, etc.) requesting the human's input. A communications adapter may be utilized to interface with the messaging platform. An intervention may also be expressed as a pull request a pull request (PR), or similar mechanism for a proposal to merge changes in a branch of code to another, on a collaborative developer platform (e.g., GitHub).

An intervention may have an associated outcome, which can indicate what actions the human performed in response to the intervention. The outcome may be expressed in a manner that corresponds with and is appropriate to the expression of the intervention. For example, when the intervention is a message through a messaging platform, the outcome may be a message in response through the messaging platform. When the intervention is a pull request on a collaborative developer platform, the outcome may be a pull request comment and/or the resulting code added or changed by the human.

An intervention database, which can be maintained by the intervention service module, can store any of: interventions, outcomes, and optionally an intervention history. An intervention and/or its associated outcome can optionally be stored in the code repository 220.

A training service module 218 may fine tune LLMs based on intervention outcomes. The training service module may obtain interventions and outcomes from the intervention service module to train LLMs. In several embodiments of the invention, when the intervention database has new data (e.g., outcomes), the updates are published to the training service module (e.g., by JSON over TCP). An LLM store can contain LLMs. LLMs may be off-the-shelf or custom. As discussed further above, certain LLMs may be more appropriate for certain types of coworker roles than others. The training service module may publish LLM model update information to the coworker service module (e.g., by JSON over TCP).

Although specific source code generation systems are discussed above with respect to FIGS. 1, 2, and 3, one skilled in the art will recognize that any of a variety of systems may be utilized in accordance with embodiments of the invention as appropriate to a particular application.

### Codebase and Indexing

In many embodiments of the invention, the code base may be indexed in a way is human readable or that an LLM can understand. For example, classes are broken down into individual properties, function names and parameters. Human readable descriptions can be included of what the classes do can be included as well as their locations. In several embodiments, indexing may be performed after project configuration is received. The project configuration can inform how indexing should be done. For example, a coworker service may have code indexed differently depending on its role, e.g., a QA engineer, a data analyst, a financial COBOL expert, etc.

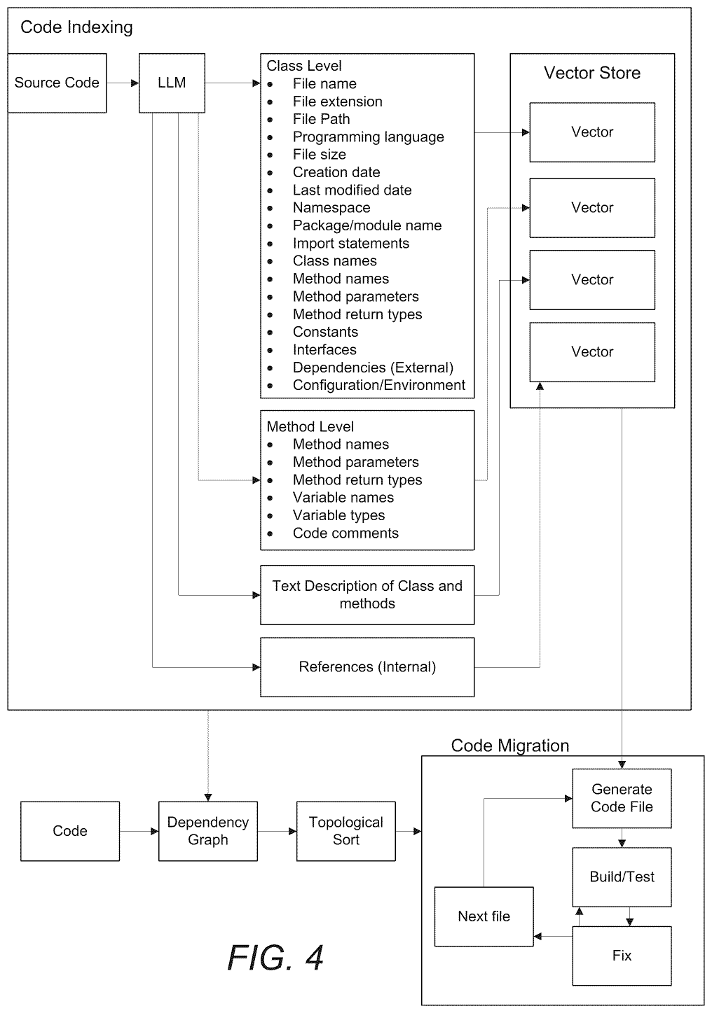

A conceptual flow of code indexing in accordance with some embodiments of invention is illustrated in FIG. 4. An LLM can be run over the original source code. Classes and methods can be organized as an abstract syntax tree (AST) or similar structure by vectorizing them and storing as vectors. Textual descriptions of classes and methods can be generated and/or extracted and stored, along with internal references between classes and/or methods. A dependency graph can be generated and used with the vectors for code migration.

While a specific approach to code indexing is described above, one skilled in the art will recognize that any of a variety of code indexing approaches may be utilized in accordance with embodiments of the invention.

### Prompts for Programming Using Machine Learning Models

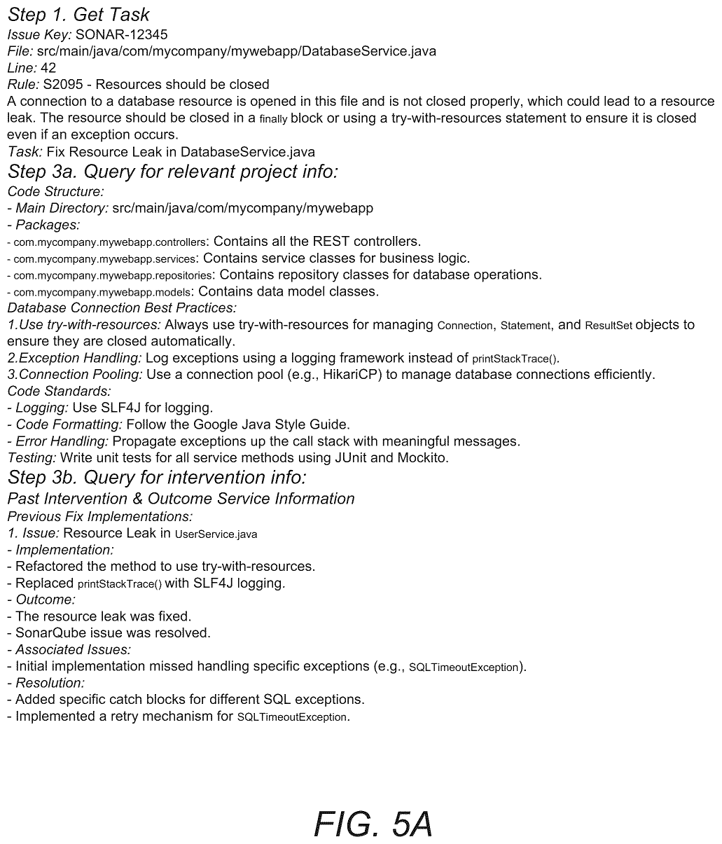

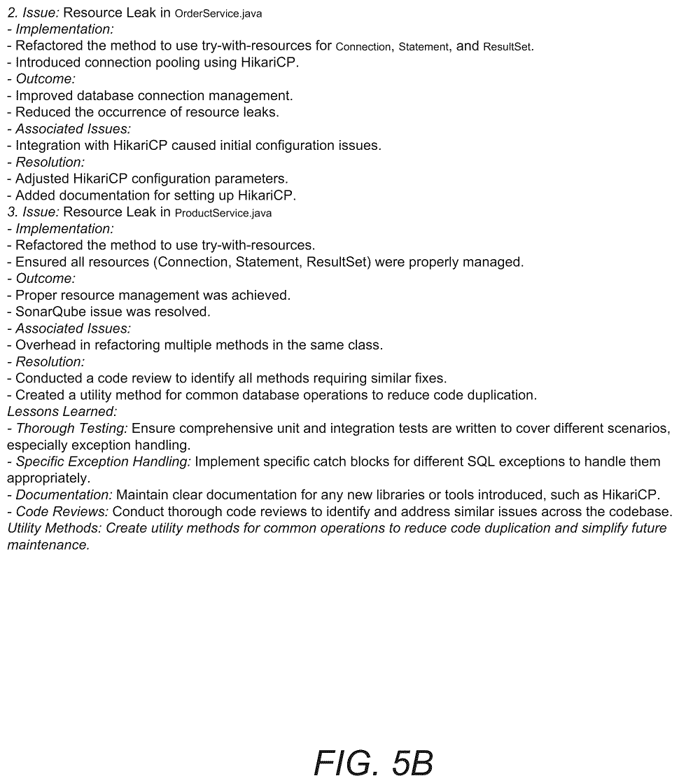

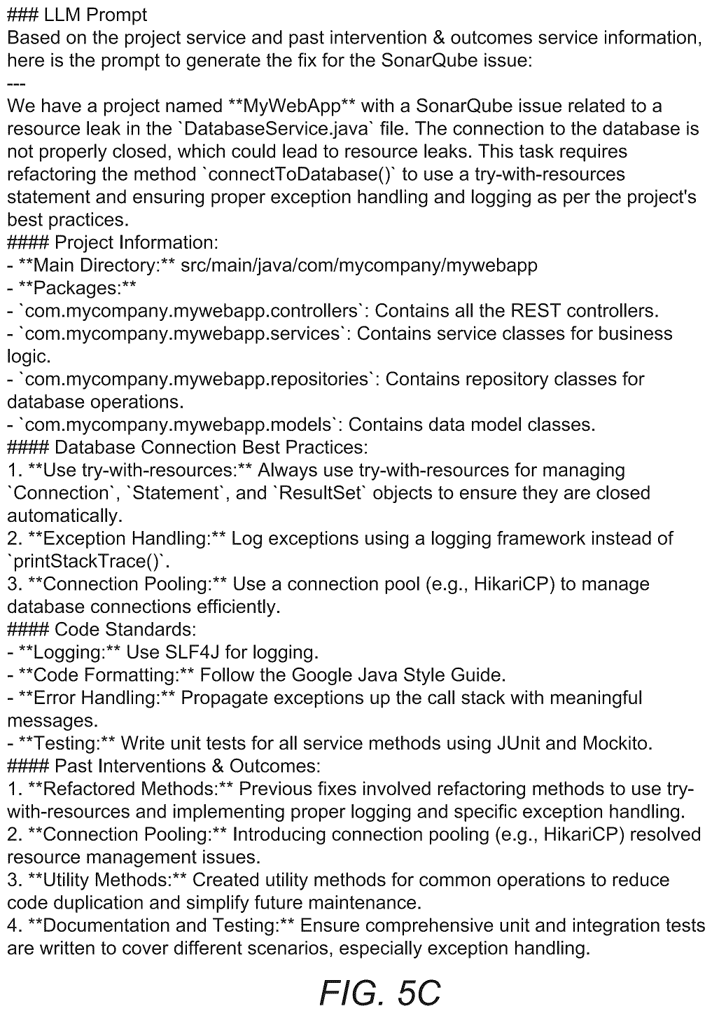

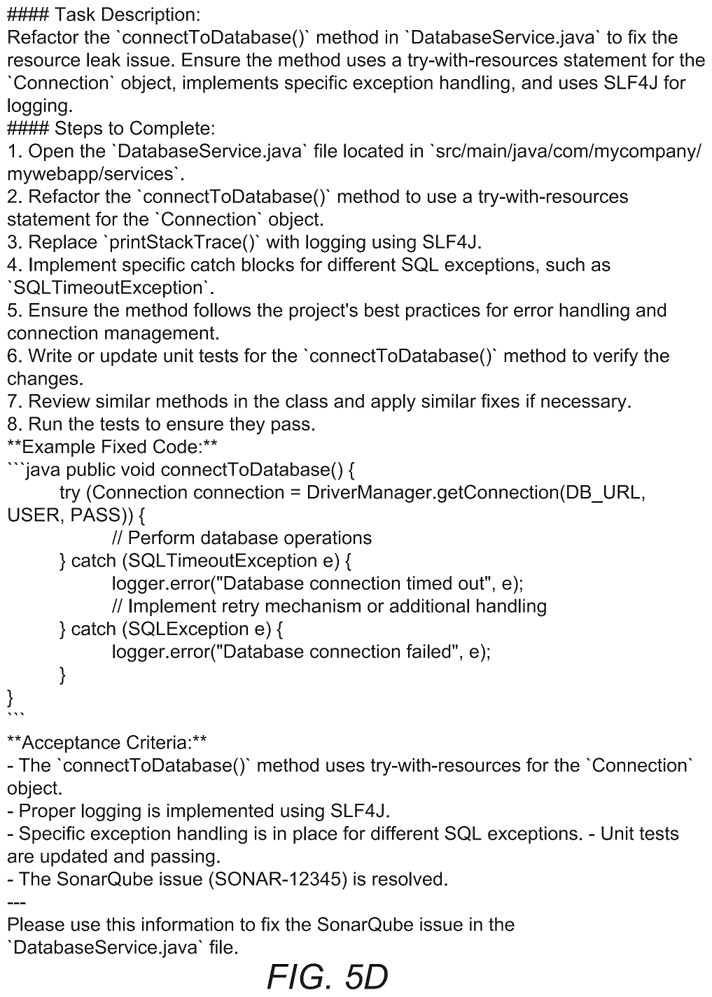

A code generation system in many embodiments of the invention can create a machine learning prompt using at least project information and intervention information. In several embodiments, a coworker service module, or in particular a prompt module within a coworker service module, can create prompts. Project information may be obtained from a project service module. Intervention information may be obtained from an intervention service module. A process for creating a prompt with information as an example in accordance with an embodiment of the invention is shown in FIGS. 5A and 5B. An example prompt resulting from the retrieved information is shown in FIGS. 5C and 5D.

A prompt generated in accordance with embodiments of the invention may include any or all of the following (from statement of the task to acceptance criteria) obtained from project information:

A statement of the task can describe the programming task and high-level objectives to accomplishing the task. For example, the task may be to resolve an issue with a resource leak in a java file by implementing proper closure of a database connection and ensuring proper exception handling and logging. As another general example, a task can be to perform testing on a particular feature of an application. In additional embodiments of the invention, a task can be to write source code that adds a feature to an application.

A location can be provided for the main directory of code of the application to be modified. A list of locations can be provided for packages that may be used in the programming task, such as but not limited to, REST controllers and classes such as service classes for business logic, repository classes for database operations, and data model classes.

A list can be provided of best practices to be implemented in the programming task.

A list can be provided of code standards, which can include log format, code format, error handling, and test methods.

A list can be provided of general steps to accomplish the task.

A list can be provided of acceptance criteria. The criteria can include performing the general steps and completing the programming task (e.g., resolving an issue) successfully.

Intervention information can include a list of past interventions and outcomes. As discussed further above, interventions can be defined as events arising during execution of a coworker service that require input from or correction by a human (e.g., developer/engineer). An intervention may have an associated outcome, which can indicate what a human did in response to the intervention (e.g., as a pull request comment).

Although specific components of a prompt are discussed above, one skilled in the art will recognize that any of a variety of components may be utilized in accordance with embodiments of the invention as appropriate to a particular application.

### Processes for Code Generation Using a Coworker

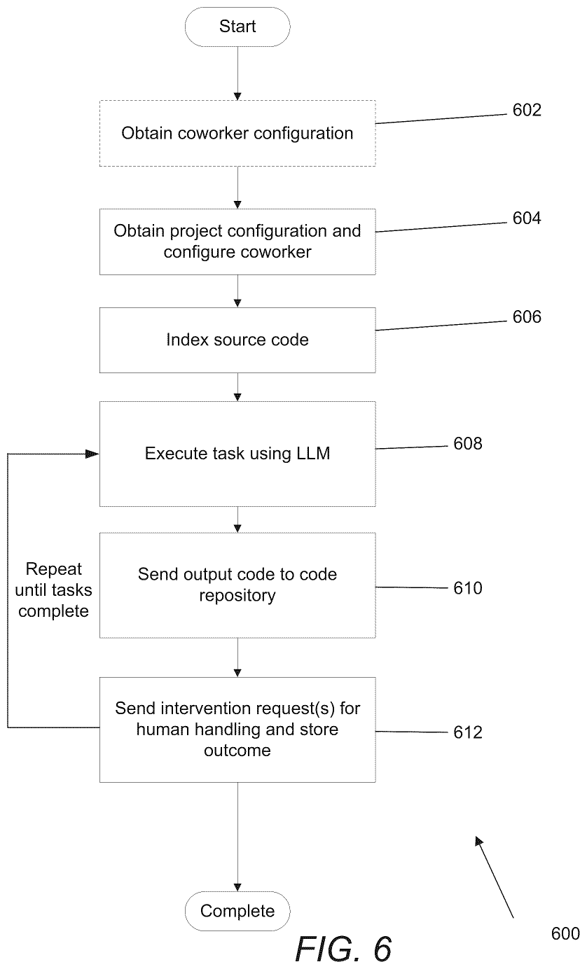

Processes for source code generation using an automated coworker in accordance with embodiments of the invention can be executed by an execution module in cooperation with other modules of a code generation server. A process for source code generation in accordance with an embodiment of the invention is illustrated in FIG. 6.

The process 600 can include capturing 602 a configuration of one or more digital coworkers on a user interface. A user may specify, using the user interface, a type of coworker and/or other settings related to a coworker service. The user may also provide project details concerning a programming task, includes receiving information describing a programming task. For example, a task can be to fix a resource leak in a file Databaseservice.java.

The process includes obtaining 604 a project configuration that can include parameters for a programming task. In some embodiments, information for the project configuration can be encapsulated and transferred by REST API (representational state transfer (REST) application programming interface (API)). The project configuration may be provided by a project service module. The process configures one or more coworker services according to the project configuration and instantiates the one or more coworker services. In several embodiments, the one or more coworker services can perform the following tasks of code indexing and task execution.

The process indexes 606 source code in the code repository. In some embodiments, the code is indexed in a way that is appropriate for a type or role of coworker service and/or given parameters from the project configuration. The indexing may be performed by the project service module.

The process retrieves 608 and executes one or more tasks by using one or more machine learning models to generate source code. A task queue may be managed by a task service module. A prompt is generated to advance the task. The prompt may be based on base prompt and include parameters from the project configuration and intervention information of past interventions as discussed further above. Source code produced by providing the prompt to an LLM can be written 610 to the code repository. In some embodiments of the invention, the code can be tested in a development environment.

In the course of executing tasks, when human input or action is required, an intervention request may be made 612. In some embodiments, interventions are handled by an intervention service module. An intervention request may involve communicating with a human user (e.g., sending a message via a team messaging tool like Slack or Teams). The human's response may be captured as input and/or the human may take actions such as making changes in source code in the code repository. Changes in source code can be communicated as an outcome to the intervention module by, for example, API calls. The input or actions can be stored as an outcome associated with the intervention in the intervention database. In some embodiments of the invention, an LLM can be fine tuned using intervention and outcome data. Updated or new LLMs can be published to the coworker service module.

Although a specific process for code generation using LLMs is discussed above, one skilled in the art will recognize that any of a variety of processes may be utilized in accordance with embodiments of the invention.

### Processes for Prompt Generation

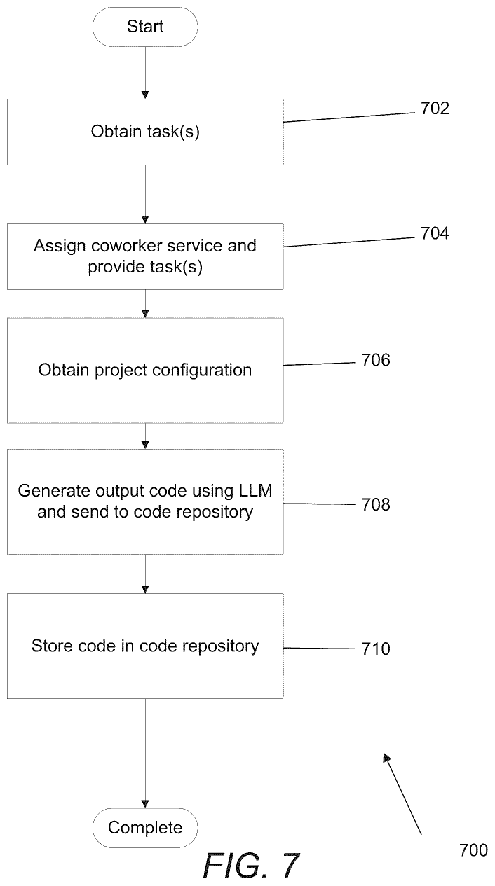

In many embodiments of the invention, processes for code generation such as those discussed above include a subprocess for prompt generation in advancing task completion using an LLM. A process for prompt generation in accordance with an embodiment of the invention is illustrated in FIG. 7.

The process 700 includes retrieving 702 one or more tasks. Tasks may be obtained, for example, by task service module and/or from project management tools.

The one or more tasks are provided 704 to one or more coworker service modules. The coworker service modules obtain 706 project configuration information (e.g., from project service module) and intervention information (e.g., from intervention service module). The coworker service modules may execute as instantiations of digital coworkers.

The coworker service module(s) generates 708 source code by providing a prompt to an LLM using at least some of the project configuration information and intervention information. A prompt can be formed as discussed further above (e.g., by a prompt module within the coworker service module).

The generated source code is sent 710 to the code repository for storage. It can be later reviewed by human engineers and/or other automated coworkers. The code can also be tested in a development environment.

Although a specific process for prompt generation is discussed above, one skilled in the art will recognize that any of a variety of processes may be utilized in accordance with embodiments of the invention.

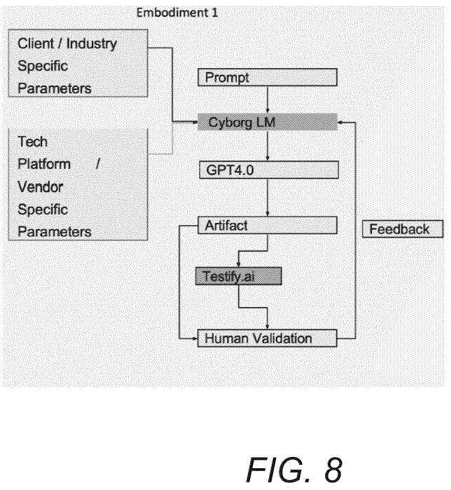

FIG. 8 illustrates a process in accordance with another embodiment of the invention. An artifact can be defined as a “test case”, which usually means an output of code, generated by GPT4.0. It can be tested in a development environment referred to as Testify.ai (machine automated validation can include whether the code builds and executes test properly). It can then be subject to human validation and feedback to determine whether to execute the programming task again.

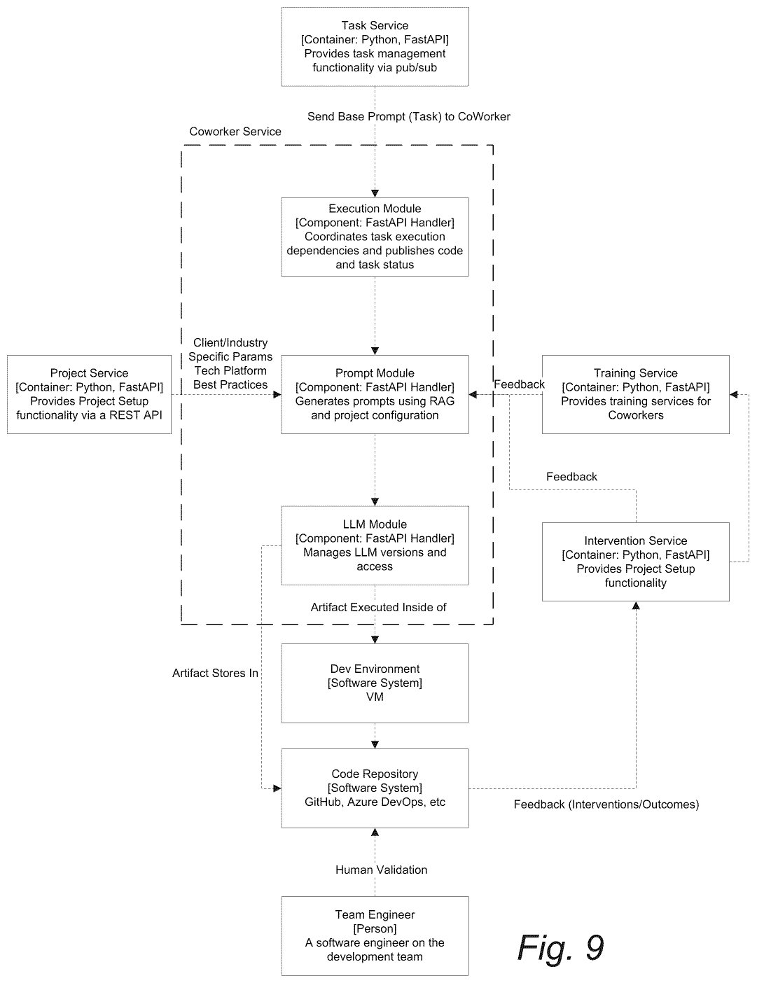

FIG. 9 illustrates a process in accordance with a further embodiment of the invention. The process corresponds similarly to the process of FIG. 8 using the terminology of modules discussed further above.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method for programmatically generating source code using a machine learning model, the method comprising:
obtaining a set of project configuration information that defines a programming task;
indexing original source code in a code repository;
advancing the programming task by constructing a prompt to a machine learning model to obtain new source code as an output;
writing the new source code to the code repository;
identifying an intervention request that requires human input to complete the programming task;
obtaining human input for the intervention request from a human using digital communications as an outcome; and
writing the intervention request and outcome to an intervention database.

2. The method of claim 1, further comprising receiving a configuration of a digital coworker and adding details to the project configuration based upon the configuration of the digital coworker.

3. The method of claim 1, wherein the project configuration information includes best practices, repo locations, and documentation locations.

4. The method of claim 1, wherein indexing source code in a code repository comprises vectorizing classes and methods within the source code.

5. The method of claim 1, wherein indexing source code in a code repository comprises inputting the source code to a machine learning model.

6. The method of claim 1, wherein indexing source code in a code repository comprises organizing classes and methods in an abstract syntax tree (AST).

7. The method of claim 1, wherein the prompt comprises project configuration information and intervention information.

8. The method of claim 1, wherein the project configuration information is obtained using REST API (representational state transfer (REST) application programming interface (API)).

9. The method of claim 1, further comprising validating the new source code.

10. The method of claim 7, wherein validating comprises manual testing by a human within a development environment.

11. The method of claim 7 wherein validating comprises automated testing the source code.

12. The method of claim 1, further comprising fine tuning the machine learning model based on at least one intervention outcome.

13. The method of claim 1, wherein the prompt includes a list of locations for code packages.

14. The method of claim 1, wherein the prompt includes a list of best practices.

15. The method of claim 1, wherein the prompt includes a list of code standards.

16. The method of claim 1, wherein the prompt includes a list of past interventions and outcomes.

17. The method of claim 1, wherein the machine learning model is a large language model (LLM).
